(19) United States
(12) Patent Application Publication
(10) Pub. No.: US 2009/0219957 A1
(43) Pub. Date: Sep. 3, 2009

(54) Radio-Frequency-Modulated Surface-Emitting Semiconductor Laser

(76) Inventors: Ulrich Steegmüller, Regensburg (DE); Thomas Schwarz, Regensburg (DE); Michael Kühnelt, Regensburg (DE); Josip Maric, Sinzing (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/992,681

(22) PCT Filed: Sep. 8, 2006
(86) PCT No.: PCT/DE2006/001570

§ 371 Date: Apr. 23, 2009

(30) Foreign Application Priority Data
Sep. 29, 2005 (DE) 10 2005 046 695.8
Nov. 18, 2005 (DE) 10 2005 055 159.9

(51) Int. Cl. H01S 3/10

(52) U.S. Cl. 372/22; 372/28

(57) ABSTRACT

In a surface emitting semiconductor laser comprising a semiconductor chip (1), a first resonator mirror (4) and at least one further resonator mirror (8) which is arranged outside the semiconductor chip (1) and forms with the first resonator mirror (4) a laser resonator having a resonator length L and a pump laser (10) which, for optically pumping the semiconductor laser (1), radiates pump radiation (14) having a pump power into the semiconductor chip (1), the pump power is modulated with a modulation frequency fₚ and the resonator length L is adapted to the modulation frequency fₚ.

The invention relates to a surface emitting semiconductor laser according to the preamble of patent claim 1.

This patent application claims the priority of German patent applications 10 2005 046 695.8 and 10 2005 055 159.9, the disclosure content of which is hereby incorporated by reference.

Solid-state lasers are generally used as modulatable lasers in the green and blue spectral range. Although said lasers have a high output power, the modulation frequency is generally restricted to less than 100 kHz on account of the long lifetime of the laser-active states in the solid-state material. Solid-state lasers of this type are often amplitude-modulated by means of external, comparatively large and expensive electro- or acousto-optical modulators.

An application of lasers in displays based on “flying spot” methods (laser scanning displays) presupposes the availability of the three primary colors red, green and blue, a comparatively high output power and also a high-frequency modulation of the lasers. In order to obtain a high resolution of the display, it is desirable to modulate the output power with a frequency of, for example, more than 1 MHz.

Surface emitting semiconductor lasers comprising an external resonator mirror, which are also known by the designations disc laser or VECSEL (Vertical External Cavity Surface Emitting Laser), are distinguished by a high output power in conjunction with high beam quality.

The document U.S. Pat. No. 6,798,804 B2 discloses a surface emitting semiconductor laser in which a high-frequency modulation of the emitted laser radiation by modulation of a voltage present at a pn junction of the surface emitting semiconductor laser is provided. A modulation unit arranged outside the semiconductor laser is used for this purpose.

The invention is based on the object of specifying an improved surface emitting semiconductor laser in which a high-frequency modulation of the emitted laser radiation is effected with comparatively low outlay.

This object is achieved by means of a surface emitting semiconductor laser having the features of patent claim 1. The dependent claims relate to advantageous configurations and developments of the invention.

In a surface emitting semiconductor laser according to the invention comprising a semiconductor chip, a first resonator mirror and at least one further resonator mirror which is arranged outside the semiconductor chip and forms with the first resonator mirror a laser resonator having a resonator length L, and a pump laser which, for optically pumping the semiconductor laser, radiates pump radiation having a pump power Pₚ into the semiconductor chip, the pump power Pₚ is modulated with a modulation frequency fₚ. The resonator length L of the laser resonator is advantageously adapted to the modulation frequency fₚ.

On account of the modulation of the pump power, the surface emitting semiconductor laser advantageously has an output power modulated with the modulation frequency fₚ of the pump power. It has been found that an adaptation of the resonator length L of the laser resonator to the modulation frequency fₚ of the pump radiation source is expedient in the case of such an optically pumped semiconductor laser. The resonator length L is preferably all the shorter, the higher the modulation frequency fₚ. In particular, the laser resonator can have a resonator length L of 30 mm or less. Preferably, the length L of the laser resonator is 20 mm or less, particularly preferably 10 mm or less. The following preferably holds true for the resonator length L: L [mm]≦250/fₚ [MHz]. By way of example, at a modulation frequency fₚ=10 MHz, the length L of the resonator is advantageously 25 mm or less. At a modulation frequency fₚ=25 MHz, the length of the resonator is advantageously not more than 10 mm.

The pump laser need not necessarily have a fixed modulation frequency, but rather can also have a variable modulation frequency. In this case, the modulation frequency should be understood to mean the maximum modulation frequency with which the pump laser can be modulated. The adaptation of the resonator length to the modulation frequency is therefore effected in this case to the maximum modulation frequency provided for the modulation of the pump power. In particular, the inequality L [mm]≦250/fₚ [MHz] is intended in this case also to be satisfied for the maximum modulation frequency of the pump laser.

In one embodiment of the invention, the modulation frequency fₚ is 1 MHz or more, preferably 10 MHz or more, and particularly preferably even 50 MHz or more.

This is advantageous in particular for a use of the surface emitting semiconductor laser in a laser display.

The pump power of the pump laser is preferably modulated by a modulation of a current with which the pump laser is operated.

In order to be able to obtain a highest possible modulation frequency fₚ, the pump laser is preferably modulated in such a way that the laser threshold of the pump laser is not undershot during the modulated operation. By way of example, the operating current of the pump laser can be varied with the frequency fₚ, the operating current, even in the minima of the temporal profile, being greater than a threshold current intensity required for the excitation of stimulated emission in the pump laser.

In order to achieve high modulation frequencies it has furthermore been found to be advantageous also to operate the surface emitting semiconductor laser during the modulated operation in such a way that the laser threshold is not undershot. This means that the high-frequency-modulated pump power, even in the minima of the temporal profile, is greater than a threshold power required for the excitation of stimulated emission in the surface emitting semiconducting laser.

The pump laser can be in particular an external pump laser, that is to say a pump laser arranged outside the semiconductor chip. The pump laser is advantageously a semiconductor laser diode.

In a further preferred embodiment of the invention, the pump laser is a pump laser that is monolithically integrated into the semiconductor chip of the surface emitting semiconductor laser. The monolithic integration of one or more pump lasers and of the surface emitting semiconductor laser on a common substrate is known in principle from the document DE 10026734, the content of which is hereby incorporated by reference.

An element for the frequency conversion of the radiation emitted by the semiconductor laser is preferably arranged in the laser resonator of the surface emitting semiconductor laser. In this case the frequency conversion can be in particular a frequency multiplication, for example a frequency doubling. By way of example, the surface emitting semiconductor laser can have an active zone provided for the emission of infrared radiation, the infrared radiation being converted into visible light, particularly preferably into green or blue visible light, within the laser resonator. The element which is provided for frequency conversion and is contained in the laser resonator can be an optically non-linear crystal, for example.

The resonator advantageously contains a wavelength filter for stabilizing the emission wavelength, for example an etalon, a birefringent filter or a bandpass filter.

The surface emitting semiconducting laser preferably has an output power averaged over time of 10 mW or more.

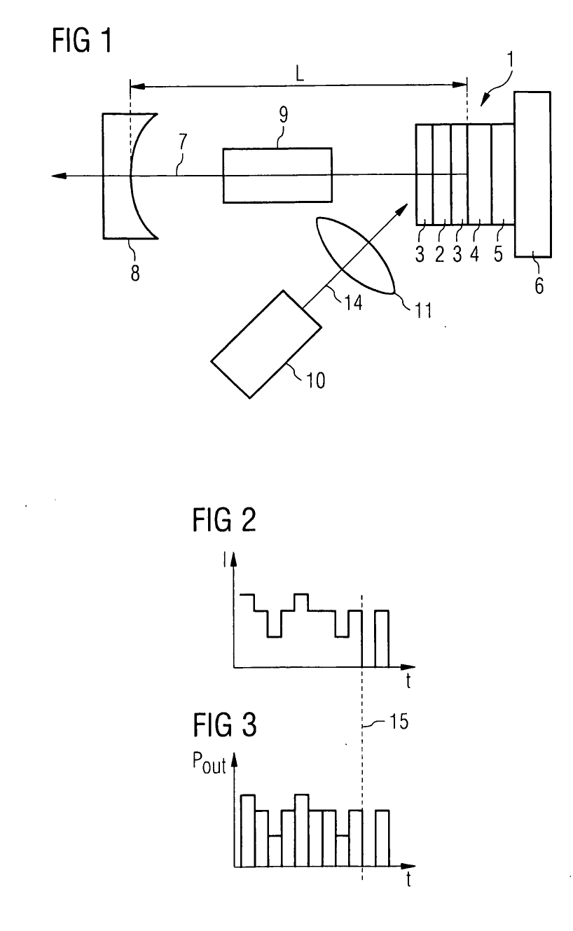

The invention is explained in more detail below on the basis of exemplary embodiments in association with FIGS. 1 to 4.

In the figures:

FIG. 1 shows a schematic illustration of a cross section through a surface emitting semiconductor laser in accordance with one exemplary embodiment of the invention,

FIG. 2 shows a schematic graphical illustration of the operating current intensity I of the pump laser as a function of the time t in the case of one exemplary embodiment of the invention,

FIG. 3 shows a schematic graphical illustration of the optical output power Pₒᵤₜ of the surface emitting semiconductor laser as a function of the time t in the case of one exemplary embodiment of the invention, and

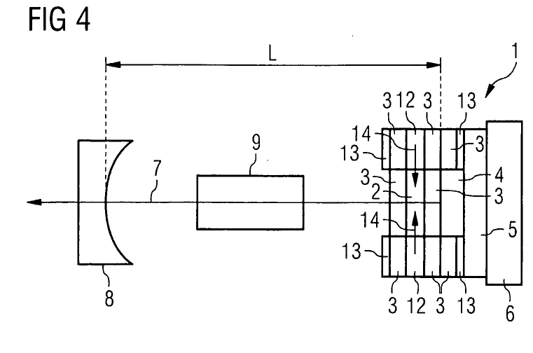

FIG. 4 shows a schematic illustration of a cross section through a surface emitting semiconductor laser in accordance with a further exemplary embodiment of the invention.

Identical or identically acting elements are provided with the same reference symbols in the figures. The elements illustrated should not be regarded as true to scale, rather individual elements may be illustrated with an exaggerated size in order to afford a better understanding.

The surface emitting semiconductor laser in accordance with a first exemplary embodiment of the invention that is schematically illustrated in cross section in FIG. 1 contains a semiconductor chip 1 containing a radiation-emitting active layer 2.

The active layer 2 is arranged in the semiconductor chip 1 between further semiconductor layers 3 functioning for example as cladding or confinement layers. The construction of a semiconductor chip of a surface emitting semiconductor laser is known in principle to the person skilled in the art and is therefore not explained in any greater detail at this juncture.

Furthermore, the semiconductor chip 1 contains a reflector 4, which represents a first resonator mirror for the laser radiation 7 emitted by the surface emitting semiconductor laser. The first resonator mirror 4 is preferably a Bragg reflector formed from a multiplicity of alternating layer pairs.

The semiconductor layers 2, 3, 4 of the semiconductor chip 1 are grown for example on a growth substrate 5. In order to improve the dissipation of heat, the semiconductor chip 1 is preferably connected to a heat sink 6, for example at a rear side of the growth substrate 5 remote from the semiconductor layers 2, 3, 4. The heat sink 6 is preferably formed from a metal having a high thermal conductivity, in particular copper. As an alternative, it is also possible to provide an actively cooled heat sink having microchannels through which a liquid or a gas flows.

The surface emitting semiconductor laser contains at least one further resonator mirror 8 which together with the first resonator mirror 4 forms a laser resonator. The second resonator mirror 8 is an external resonator mirror which is arranged outside the semiconductor chip 1 and which has a concave curvature for example on a side facing the semiconductor chip 1.

As an alternative to the exemplary embodiment illustrated in FIG. 1, in which the first resonator mirror 4 and the second resonator mirror 8 form a linear laser resonator, the surface emitting semiconductor laser could also have one or more further resonator mirrors which together form a folded resonator (not illustrated).

The excitation of the active layer 2 for stimulated emission of laser radiation 7 is effected by optical pumping by means of a pump laser. The pump laser 10 is for example a semiconductor laser which is arranged outside the semiconductor chip 1 and which radiates pump radiation 14 into the active layer 2 of the semiconductor chip 1.

The pump power of the pump radiation 14 emitted by the pump laser 10 is modulated with a frequency fₚ of for example 1 MHz or more. The modulation frequency fₚ is preferably more than 10 MHz. In particular, a modulation frequency of 50 MHz or more can also be provided. The length L of the laser resonator is adapted to the modulation frequency of the pump power. In particular, at a high modulation frequency fₚ it is advantageous for the laser resonator of the surface emitting semiconductor laser to have a comparatively short length L. The length L of the laser resonator is advantageously 30 mm or less. The length L of the laser resonator is preferably 20 mm or less, particularly preferably even 10 mm or less.

In particular, it has proved to be advantageous if the length L of the laser resonator at a predetermined modulation frequency fₚ does not exceed a value for which the following holds true: L [mm]≦250/fₚ [MHz]

The active layer 2 is preferably formed as a quantum well structure. In this case, the designation quantum well structure encompasses any structure in which charge carriers experience a quantization of their energy states as a result of confinement. In particular, the designation quantum well structure does not comprise any indication about the dimensionality of the quantization. It therefore encompasses, inter alia, quantum wells, quantum wires and quantum dots and any combination of these structures.

The active layer 2 of the surface emitting semiconductor laser is preferably based on a phosphide compound semiconductor or arsenide compound semiconductor. This means that the active layer 2 preferably comprises InₓAl_{y}Ga_{1-x-y}P or InₓAl_{y}Ga_{1-x-y}As, where 0≦x≦1, 0≦y≦1 and x+y≦1 holds true. In particular, the active layer 2 can have a quantum well structure suitable for emission of infrared radiation.

As an alternative, it is also possible for the active layer to be provided for emission of visible or ultraviolet radiation. By way of example, the active layer can comprise InₓAl_{y}Ga_{1-x-y}N, where 0≦x≦1, 0≦y≦1 and x+y≦1 holds true.

The semiconductor material of the active layer 2 need not necessarily have a mathematically exact composition according to one of the abovementioned formulae. Rather, it can have one or more dopants and additional constituents which essentially do not change the physical properties of the material. For the sake of simplicity, however, the above formulae only comprise the essential constituents of the crystal lattice (Al, Ga, In, P or As or N), even if these can be replaced in part by small quantities of further substances.

In a preferred embodiment of the invention, the laser resonator contains an element 9 suitable for the frequency conversion of the radiation 7 emitted by the semiconductor laser. The frequency conversion element 9 is preferably a non-linear optical crystal. A frequency multiplication, in particular a frequency doubling, of the emitted laser radiation 7 is advantageously obtained by means of the frequency conversion element 9.

In a particularly preferred embodiment of the invention, the active layer 2 is a layer emitting infrared radiation, the emitted laser radiation 7 being converted into visible light, in particular into green visible light, by means of the frequency conversion element 9.

The pump radiation 14 is advantageously focussed into the active layer 2 of the semiconductor chip 1 through an optical element 11. The optical element 11 can be a diffractive optical element or a refractive optical element, for example a lens.

The high-frequency modulation of the pump power Pₚ is preferably effected by a correspondingly high-frequency modulation of the operating current intensity of the pump laser 10. The pump laser 10 is therefore a high-frequency-modulated electrically pumped semiconductor laser.

FIGS. 2 and 3 schematically graphically illustrate an exemplary temporal profile of the operating current intensity I of the pump laser 10 and the output power Pₒᵤₜ of the surface emitting semiconductor laser. By virtue of the fact that the active layer 2 of the semiconductor chip 1 of the surface emitting semiconductor laser is optically pumped by the high-frequency-modulated pump laser 10, the output power Pₒᵤₜ of the laser radiation 7 emitted by the surface emitting semiconductor laser is also modulated with the modulation frequency fₚ of the operating current intensity I of the pump laser.

In order to be able to obtain a highest possible modulation frequency, it is advantageous if the operating current of the pump laser 10 is modulated in such a way that a threshold current intensity Iₛ required for the excitation of the laser emission of the pump laser is not undershot. Furthermore, it is advantageous if the output power of the surface emitting semiconductor laser also does not undershoot a threshold power Pₛ below which the emission of laser radiation would otherwise cease. This is the case in the region to the left of the dashed line 15 for example in the temporal profiles of the operating current Iₛ and the output power Pₒᵤₜ as illustrated in FIGS. 2 and 3.

A further preferred exemplary embodiment of the surface emitting semiconductor laser according to the invention is schematically illustrated in cross section in FIG. 4.

The surface emitting semiconductor laser of this exemplary embodiment differs from the exemplary embodiment illustrated in FIG. 1 by virtue of the fact that it does not have a pump laser arranged outside the semiconductor chip 1. In contrast to this, the surface emitting semiconductor laser illustrated in FIG. 4 contains a pump laser 12 which is monolithically integrated into the semiconductor chip 1. The pump laser 12 is an edge emitting semiconductor laser which radiates pump radiation 14 in a lateral direction into the active layer 2 of the surface emitting semiconductor laser. The active layer 2 of the surface emitting semiconductor laser is preferably surrounded by the pump laser 12 on both sides in a lateral direction. In a vertical direction, the pump laser 12 is surrounded by further semiconductor layers 3 which function in particular as waveguides for the pump radiation 14 and are provided for impressing current into the active layer of the pump laser 12.

The monolithic integration of the pump laser 12 into the semiconductor chip 1 of the surface emitting semiconductor laser has the advantage, in particular, that the outlay for the alignment of an external pump laser is obviated. Furthermore, an effective and homogeneous optical pumping of the active layer 2 is ensured on account of the pump radiation 14 being laterally radiated into the active layer 2 of the surface emitting semiconductor laser.

The monolithically integrated pump laser 12 is an electrically pumped semiconductor laser into which an operating current I is impressed by means of electrical contacts 13.

The high-frequency modulation of the output power Pₒᵤₜ of the surface emitting semiconductor laser is effected in a manner analogous to that in the case of the semiconductor laser described above in association with FIG. 1. The operating current I of the monolithically integrated pump laser 12 is therefore modulated with a modulation frequency fₚ of preferably 1 MHz or more in order in this way also to modulate at high frequency the output power Pₒᵤₜ of the surface emitting semiconductor laser with the modulation frequency fₚ of the pump laser 12.

The further advantageous configurations of the invention that were explained above in association with FIGS. 1 to 3 also hold true, of course, for the exemplary embodiment illustrated in FIG. 4.

The invention is not restricted by the description on the basis of the exemplary embodiments. Moreover, the invention encompasses any new feature and also any combination of features, which in particular comprises any combination of features in the patent claims, even if this feature or this combination itself is not explicitly specified in the patent claims or exemplary embodiments.

1. A surface emitting semiconductor laser comprising a semiconductor chip (1), a first resonator mirror (4) and at least one further resonator mirror (8) which is arranged outside the semiconductor chip (1) and forms with the first resonator mirror (4) a laser resonator having a resonator length L and at least one pump laser (10, 12) which, for optically pumping the semiconductor laser (1), radiates pump radiation (14) having a pump power into the semiconductor chip (1),
wherein
the pump power is modulated with a modulation frequency fₚ and the laser resonator has a resonator length L adapted to the modulation frequency fₚ.

2. The surface emitting semiconductor laser according to claim 1,
wherein
the following holds true for the resonator length L: L [mm]≦250/fₚ [MHz].

3. The surface semiconductor laser according to claim 1,
wherein
the following holds true for the modulation frequency fₚ: fₚ≧1 MHz.

4. The surface emitting semiconductor laser according to claim 1,
wherein
the following holds true for the modulation frequency fₚ: fₚ≧10 MHz.

5. The surface emitting semiconductor laser according to claim 1,
wherein
the following holds true for the modulation frequency fₚ: fₚ≧50 MHz.

6. The surface emitting semiconductor laser according to claim 1,
wherein
the resonator length L is 30 mm or less, preferably 20 mm or less.

7. The surface emitting semiconductor laser according to claim 1,
wherein
the pump power is modulated by a modulation of a current I with which the pump laser (10, 12) is operated.

8. The surface emitting semiconductor laser according to claim 1,
wherein
the pump power is modulated in such a way that a laser threshold of the pump laser is not undershot during the modulated operation.

9. The surface emitting semiconductor laser according to claim 1,
wherein
a laser threshold of the surface emitting semiconductor laser is not undershot during the modulated operation.

10. The surface emitting semiconductor laser according to claim 1,
wherein
the pump laser is monolithically integrated into the semiconductor chip of the surface emitting semiconductor laser.

11. The surface emitting semiconductor laser according to claim 1,
wherein
the pump laser is arranged outside the semiconductor chip.

12. The surface emitting semiconductor laser according to claim 1,
wherein
a frequency conversion element for the frequency conversion of the radiation emitted by the semiconductor laser is arranged in the laser resonator.

13. The surface emitting semiconductor laser according to claim 12,
wherein
the frequency conversion is a frequency multiplication, in particular a frequency doubling.

14. The surface emitting semiconductor laser according to claim 12,
wherein
the semiconductor chip emits infrared radiation which is converted into visible light, in particular into green visible light, by the frequency conversion element.

15. The surface emitting semiconductor laser according to claim 1,
wherein
an optical output power of the surface emitting semiconductor laser is 10 mW or more.
